(19) United States
(12) Patent Application Publication
(10) Pub. No.: US 2025/0249683 A1
(43) Pub. Date: Aug. 7, 2025

(54) DROP-ON-DEMAND PRINT HEAD MAINTENANCE IN A CARD PERSONALIZATION SYSTEM

(71) Applicant: Entrust Corporation, Shakopee, MN (US)

(72) Inventor: Brendan Hinnenkamp, Shakopee, MN (US)

(21) Appl. No.: 19/033,024

(22) Filed: Jan. 21, 2025

Related U.S. Application Data
(60) Provisional application No. 63/627,945, filed on Feb. 1, 2024.

(51) Int. Cl. B41J 2/165; B41J 2/17; B41M 3/00; B41M 7/00

(52) U.S. Cl. CPC B41J 2/16526; B41J 2/1721; B41M 3/005; B41M 7/0081

(57) ABSTRACT

Techniques are described for maintaining a DOD print head in a print mechanism of a card or passport personalization system, where the DOD print head prints using ink that is difficult to handle and dispose of in an unaltered form of the ink. A maintenance ejection of waste ink is performed. The waste ink is then altered, for example by curing in the case of a radiation curable ink, while the waste ink is within the card or passport personalization system. This makes the waste ink easier to handle and dispose of.

This application claims the benefit of U.S. Provisional Application No. 63/627,945 filed on Feb. 1, 2024, the entire contents of which are incorporated herein by reference.

### FIELD

This technical disclosure relates to maintaining drop-on-demand (DOD) print heads used in card or passport personalization systems.

### BACKGROUND

In DOD printing, ink is ejected from one or more nozzles of a print head by electrically energizing select ones of the nozzles from which the ink is to be ejected. If a nozzle is not used periodically, the nozzle can become completely or partially clogged with ink or other debris preventing its operation or causing the nozzle to eject ink incorrectly. U.S. Pat. No. 11,072,169 describes an example of a card processing system that employs automated maintenance routines on a DOD print head to prevent clogging of the DOD print head. U.S. Pat. No. 11,072,169 is incorporated herein by reference in its entirety.

Some inks, such as radiation curable inks, used in DOD printing are formulated such that waste ink that results from maintenance routines like described in U.S. Pat. No. 11,072,169 is difficult to handle and dispose of in an unaltered form of the waste ink.

### SUMMARY

Techniques are described for maintaining a DOD print head in a print mechanism of a card or passport personalization system, where the DOD print head prints using ink that is difficult to handle and dispose in an unaltered form of the ink. As described in further detail below, waste ink that results from a maintenance routine on a DOD print head is altered while the waste ink is within the card or passport personalization system and after the waste ink is ejected in a maintenance routine to make the waste ink easier to handle and dispose of.

An ejection of ink during a maintenance routine differs from an ejection of ink during a print job. The ejection of ink during the maintenance routine creates waste ink and typically does not create printing, such as an image and/or alphanumeric characters, on a card or passport. The ink that is ejected during a print-job (which may be referred to as print-job ink) creates printing, such as an image and/or alphanumeric characters, on a card or passport.

The ink described herein, whether ejected in a maintenance routine or during a print job, is difficult to handle and dispose of in its unaltered form. After the ink is ejected in a maintenance routine and becomes waste ink, the waste ink is altered, for example making the waste ink less reactive, within the personalization system to render the waste ink easier to handle and to dispose of.

The ink described herein may be a curable ink. An example of a curable ink is a radiation curable ink that is cured by application of radiation to the ink, such as ultra-violet (UV) ink. Alternatively, the curable ink may be a heat curable ink that is cured by application of heat. Curing is one form of rendering a curable waste ink easier to handle and dispose of. However, any other technique that results in rendering the waste ink easier to handle and dispose of can be used.

The maintenance ejection of ink can be any ejection of ink from the DOD print head that creates waste ink, including the ejection of ink during any one or more of the maintenance routines described in U.S. Pat. No. 11,072,169 which is incorporated herein by reference in its entirety.

In one embodiment, a method of maintaining a drop-on-demand print head in a print mechanism of a card or passport personalization system comprises within the card or passport personalization system, conducting a maintenance ejection of waste radiation curable ink from the drop-on-demand print head. Within the card or passport personalization system, radiation is applied to the ejected waste radiation curable ink to cure the ejected radiation curable ink. In addition, after the maintenance ejection, for example after the waste ink is cured, the print mechanism is used to print an image on a card or a passport with radiation curable ink.

In another embodiment, a method of maintaining a drop-on-demand print head in a print mechanism of a card or passport personalization system comprises within the card or passport personalization system, conducting a maintenance ejection of waste curable ink from the drop-on-demand print head onto a waste ink receiver. Within the card or passport personalization system, the ejected waste curable ink is cured. Thereafter, the print mechanism is used to print on a card or a passport with curable ink. In this version of the method, an amount of the waste curable ink ejected in the maintenance ejection is greater than an amount of the curable ink used to print on the card or the passport.

In another embodiment, a method of maintaining a drop-on-demand print head in a print mechanism of a card or passport personalization system comprises within the card or passport personalization system, conducting a maintenance ejection of waste ink from the drop-on-demand print head onto a waste ink receiver. Within the card or passport personalization system, the ejected waste ink is altered, for example by making the ejected waste ink less reactive. Thereafter, the print mechanism is used to print on a card or a passport with ink.

### DRAWINGS

FIG. 1 illustrates a DOD print head maintenance method described herein.

FIG. 2 illustrates another DOD print head maintenance method described herein.

FIG. 3 illustrates a portion of a print mechanism of a card or passport personalization system, with the print mechanism including a DOD print head.

FIG. 4 illustrates an example of a waste ink receiver.

FIG. 5 illustrates another example of a waste ink receiver.

FIG. 6 schematically illustrates an embodiment of a card or passport personalization system that can utilize the print mechanism of FIG. 3.

### DETAILED DESCRIPTION

As used herein, the word “step” should be construed, unless otherwise indicated by Applicant, as including a single step or multiple sub-steps resulting in the step.

The following describes techniques for maintaining a DOD print head in a print mechanism of a card or passport personalization system, where the DOD print head prints using ink that is hard to handle and dispose of in an unaltered form of the ink. For sake of simplicity, the following will describe the card or passport personalization system as simply a card personalization system that prints on cards. However, the techniques described herein can be used in systems that personalize passports. The term “personalize” (or the like) as used throughout the specification and claims, unless indicated otherwise, is intended to encompass operations performed on a card (or a page of a passport) that includes operations that result in personalizing the card as well as operations that do not result in personalizing the card. An example of a personalization operation that personalizes the card is printing the cardholder's image or name (using alphanumeric characters) on the card. An example of a personalization operation that does not personalize the card is printing non-card holder graphics on the card. The term “personalize” is often used in the personalized card industry to refer to cards that undergo both personalization processing operations and non-personalization processing operations.

Waste ink as used herein refers to ink that is discharged in a maintenance ejection. The waste ink that results from the maintenance ejection on a DOD print head is altered while the waste ink is within the card personalization system and after the waste ink is ejected from the DOD print head in a maintenance routine. Altering the ink renders the waste ink less reactive and easier to handle and dispose of. An ejection of ink during a maintenance routine differs from an ejection of ink during a print job on the card. The ejection of ink during the maintenance routine creates waste ink and typically does not create printing, such as an image and/or alphanumeric characters, on the card. The ink that is ejected during a print-job (which may be referred to as print-job ink) creates printing, such as an image and/or alphanumeric characters, on the card. In an embodiment, an amount of the waste ink that is ejected in the maintenance ejection is greater than an amount of the ink used to print an image on a card. In another embodiment, an amount of the waste ink that is ejected in the maintenance ejection is less than an amount of the ink used to print an image on a card. In still another embodiment, an amount of the waste ink that is ejected in the maintenance ejection is substantially the same as an amount of the ink used to print an image on a card.

The ink described herein, whether ejected in a maintenance routine or during a print job is difficult to handle and dispose of in an unaltered form of the ink. After the ink is ejected in a maintenance routine and becomes waste ink, the waste ink is altered to render the waste ink easier to handle and dispose of compared to an unaltered form of the waste ink.

The ink described herein may be a curable ink. An example of a curable ink is a radiation curable ink that is cured by application of radiation, such as ultra-violet (UV) radiation, to the ink. Curing the radiation curable ink alters the ink and renders the ink less reactive and easier to handle and dispose of compared to the uncured ink. The use of radiation curable inks in card personalization systems is well known. Alternatively, the curable ink may be a heat curable ink that is cured by application of heat. Curing is one form of altering a curable waste ink to make the waste ink easier to handle and dispose of. However, any other technique that results in altering the waste ink can be used.

The maintenance ejection of ink described herein can be any ejection of the ink involved with maintaining the operability of a DOD print head. U.S. Pat. No. 11,072,169 describes a number of maintenance routines on a DOD print head that result in a maintenance ejection of ink. These maintenance routines are referred to as “spitting” and “purging”. However, other maintenance ejections of ink are intended to be encompassed herein.

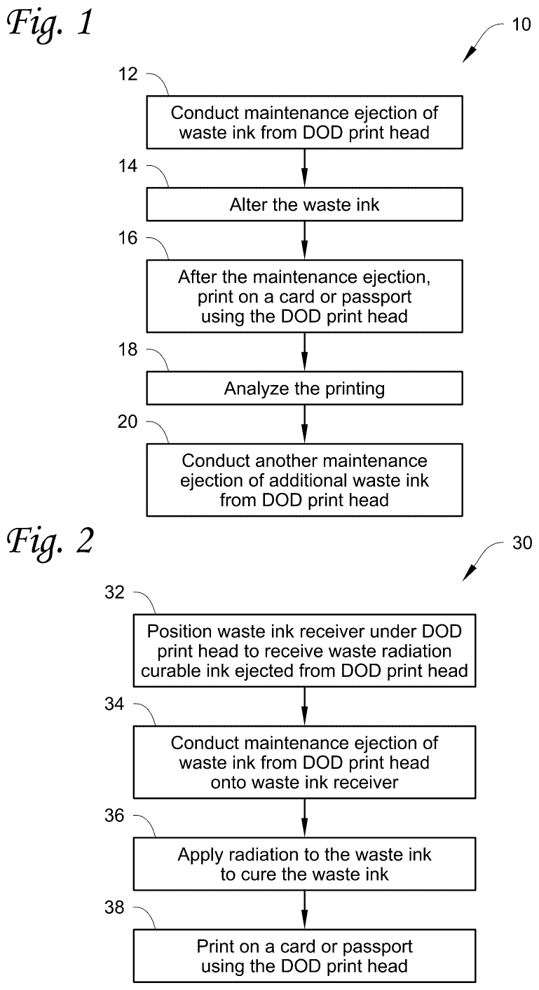

Referring to FIG. 1, an example of a DOD print head maintenance method 10 is illustrated. In the method 10, a maintenance ejection of waste ink from the DOD print head is conducted at step 12. The maintenance ejection can be a “spit”, a “purge” or any other form of maintenance ejection of the ink intended to maintain the operability of the DOD print head. In an embodiment, the ink may be a radiation curable ink that is cured by application of radiation, such as UV radiation, to the ink.

In an embodiment, the maintenance ejection of ink in step 12 occurs so that the waste ink is ejected onto a waste ink receiver within the print mechanism of the card personalization system. The waste ink can be ejected onto a surface of the waste ink receiver, into a cavity or receptacle of the waste ink receiver, or into or onto any other location of the waste ink receiver. The waste ink receiver is any structure within the print mechanism onto which the waste ink can be ejected. The waste ink receiver may be configured to be brought into position underneath the DOD print head in order for the waste ink to be discharged thereon. In another embodiment, the DOD print head is mounted so as to be moveable and the DOD print head is brought into position over the waste ink receiver which may be stationary. Alternatively, both the DOD print head and the waste ink receiver may be moveable so as to be brought into position relative to one another in order for the waste ink to be discharged onto the waste ink receiver. The waste ink receiver may be configured to receive a single ejection of waste ink after which the waste ink receiver is disposed of, for example by storing the waste ink receiver in a discard storage location in the card personalization system or discharging the waste ink receiver from the card personalization system. In another embodiment, the waste ink receiver may be configured to be reused one or more additional times to receive multiple ejections of waste ink.

An example of a waste ink receiver is a card shaped substrate 50 depicted in FIG. 4. The substrate 50 may have a shape and size suitable for the substrate 50 to be handled by the card transport mechanism(s) in the card personalization system. For example, the substrate 50 may have a shape and size corresponding to an ID-1 card (85.60 by 53.98 millimeters) as defined by ISO/IEC 7810. The substrate 50 may be fed into the card personalization system, for example manually by an operator or fed via an input hopper mechanism that contains one or more of the substrates 50 waiting for use. An example of a mechanism with multiple input hoppers that can hold regular cards to be printed on in one input hopper and hold one or more of the substrates 50 in a second input hopper is disclosed in U.S. Pat. No. 10,699,509 the entire contents of which are incorporated herein by reference. The substrate 50 is then transported into the printing mechanism and positioned relative to the DOD print head in order for the waste ink to be discharged onto a surface of the substrate 50. In this embodiment, the card shaped substrate 50 may be a blank card that is devoid of an integrated circuit chip and devoid of a magnetic strip commonly found on cards such as credit cards, identification cards, and the like.

FIG. 5 depicts another example of a waste ink receiver that is also in the form of a card shaped substrate 60 having a shape and size suitable for the substrate 60 to be handled by the card transport mechanism(s) in the card personalization system. For example, the substrate 50 may have a shape and size corresponding to an ID-1 card (85.60 by 53.98 millimeters) as defined by ISO/IEC 7810. The substrate 60 may be fed into the card personalization system, for example manually by an operator or fed via an input hopper mechanism that contains one or more of the substrates 60 waiting for use. An example of a mechanism with multiple input hoppers that can hold one or more of the substrates 60 is disclosed in U.S. Pat. No. 10,699,509 the entire contents of which are incorporated herein by reference. The substrate 60 may be a regular card that is fed from an input hopper and used as the substrate 60. The substrate 60 is then transported into the printing mechanism and positioned relative to the DOD print head in order for the waste ink to be discharged onto a surface of the substrate 60. In this embodiment, the card shaped substrate 60 may be similar in construction to a conventional card such as a credit card, an identification card or the like in that the substrate 60 includes a programmable integrated circuit chip 62 and/or an encodeable magnetic strip 64.

Other waste ink receivers are possible. For example, the waste ink receiver may be a structure like the covering cap, or that functions like the covering cap, described in U.S. Pat. No. 11,072,169. In another embodiment, the waste ink receiver may be a ribbon or film. Other waste ink receivers are possible.

Returning to FIG. 1, the waste ink that has been ejected onto the waste ink receiver is altered at step 14. In one embodiment, after the ejection of the waste ink onto the waste ink receiver, the waste ink receiver with the waste ink thereon is transported to a position for altering the waste ink. For example, when the waste ink is radiation curable ink, the waste ink receiver is transported to a position for UV light emitted by one or more UV light emitters to reach the waste ink and thereby cure the waste ink. In another embodiment, when the waste ink is heat or thermally curable ink, the waste ink receiver is transported to a position for heat emitted by one or more heat emitters to reach the waste ink and thereby cure the waste ink. Any other technique for altering the waste ink to render the waste ink easier to handle and dispose of can be used.

In step 14, altering the waste ink can occur in the print mechanism whereby the waste ink receiver is within the print mechanism. In another embodiment, the waste ink receiver can be transported out of the print mechanism and the waste ink is then altered. The waste ink receiver can be brought into position relative to the UV light emitter(s) or other device for altering the waste ink, the UV light emitter(s) or other device for altering the waste ink can be brought into position relative to the waste ink receiver, or both the UV light emitter(s) or other device for altering the waste ink and the waste ink receiver can be movable so as to position them relative to one another.

Once the waste ink is altered, the waste ink receiver may be actuated to a storage position, for example in the print mechanism or in any other location in the card personalization system. For example, in the case of the card-shaped substrate 50 or 60, the substrate 50 or 60 can be transported into a storage hopper that stores the substrate for later removal from the system. Alternatively, the waste ink receiver may be discharged from the system. For example, in the case of the card-shaped substrate 50 or 60, the substrate 50 or 60 can be transported to an exit and discharged from the system. If the waste ink receiver is to be re-used one or more times to receive additional ejections of waste ink, the waste ink receiver may be positioned in the system to allow the waste ink receiver to be returned to a position back underneath the DOD print head.

Returning to FIG. 1, in step 16, sometime after the maintenance ejection of the waste ink, the DOD print head is used to print an image and/or alphanumeric characters on a card in a print job. The print job can occur after the waste ink is altered in step 14, before the waste ink is altered in step 14, or while the waste ink is being altered in step 14. The printing on the card that results from the print job may be personal information of the intended card holder, such as a portrait image, cardholder name, an account number assigned to the cardholder, and the like. In the case of radiation curable ink, the print-job ink that is applied in a print job is cured using UV radiation.

Optionally, the printing that results from step 16 may be analyzed in step 18, for example manually by an operator or using a vision system such as a camera, to determine whether the maintenance ejection of waste ink in step 12 was successful. Clogging and other related issues with the DOD print head are intended to be eliminated by the maintenance ejection of the waste ink. If these issues are not resolved, problems with the printing in step 16 may result, for example in the form of breaks in the printing, missing sections of the printing, blurring of the printing, etc. These problems are readily ascertainable by a human operator or via a vision system. If problems are detected in step 18, an additional maintenance ejection of additional waste ink in step 20 can be performed. Step 20 can be performed in the same manner as step 12. If step 20 is performed, a step like the step 14 can be performed to alter the ejected additional waste ink.

Referring to FIG. 2, another example of a DOD print head maintenance method 30 is illustrated. In the method 30, in step 32 the waste ink receiver is positioned under the DOD print head to receive the ejected waste ink, which in this example is radiation curable ink. The waste ink receiver and the positioning thereof relative to the DOD print head can be as described above for the method 10 of FIG. 1. Thereafter, a maintenance ejection of waste ink from the DOD print head is conducted at step 34. Step 34 can be conducted substantially identically to step 12 described above.

Thereafter, in step 36, radiation is applied to the waste ink to cure the waste ink. In an embodiment, the waste ink receiver may be transported to a position for UV light emitted by one or more UV light emitters to reach the waste ink and thereby cure the waste ink which alters the radiation curable ink. In step 38, sometime after the maintenance ejection of the waste ink in step 34, the DOD print head is used to print an image and/or alphanumeric characters on a card in a print job. The print job can occur after the waste ink is cured in step 36, before the waste ink is cured in step 36, or while the waste ink is being cured in step 36. The printing on the card that results from the print job may be personal information of the intended card holder, such as a portrait image, cardholder name, an account number assigned to the cardholder, and the like. Optionally, steps identical to steps 18 and 20 in the method 10 of FIG. 1 can take place after the step 38.

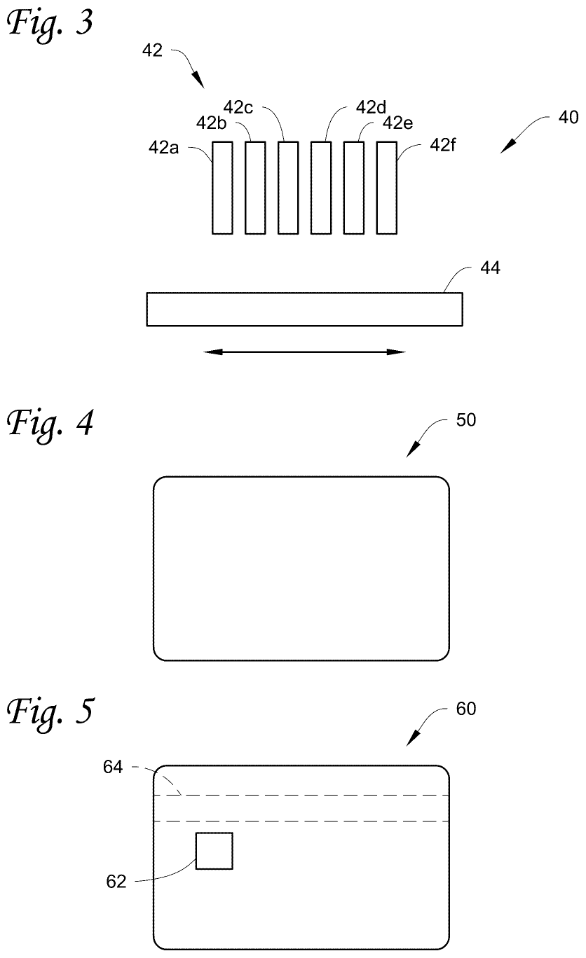

FIG. 3 illustrates a portion of a print mechanism 40 of a card (or passport) personalization system. The print mechanism 40 includes one or more DOD print heads 42. The illustrated example depicts 6 total DOD print heads, one print head 42a for printing cyan (C), one print head 42b for printing magenta (M), one print head 42c for printing yellow (Y), one print head 42d for printing black (K), one print head 42e for printing white (W), and one print head 42f for printing a varnish. A larger or smaller number of DOD print heads 42 can be used. Each DOD print head 42 includes one or more nozzles that are electrically energizable to eject ink. If a nozzle is not used periodically, the nozzle can become completely or partially clogged with ink or other debris preventing its operation or causing the nozzle to eject ink incorrectly. The construction and operation of DOD print heads in card personalization systems is well known.

FIG. 3 illustrates a waste ink receiver 44 positioned underneath the DOD print heads 42 ready to receive a maintenance ejection of waste ink from one or more of the print heads 42. The receiver 44 may be actuatable left and/or right in the directions of the arrows in FIG. 3 to bring the receiver 44 into position underneath the print heads 42. Alternatively, or additionally, the receiver 44 may be actuatable in a direction that is into or out of the plane of FIG. 3 to bring the receiver 44 into position underneath the print heads 42.

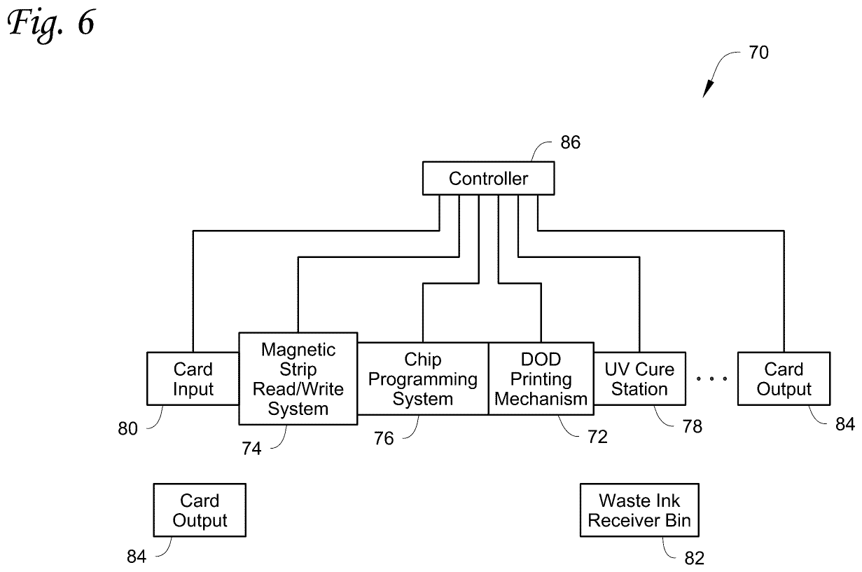

FIG. 6 illustrates an example of a card personalization system 70 described herein. The system 70 is configured to process cards by at least printing on the cards using the DOD printing mechanism 72 included in the system 70. The DOD printing mechanism 72 can have a construction like the printing mechanism 40 described above in FIG. 3. The system 70 can also include at least one other card processing capability in addition to the printing by the DOD printing mechanism 72. For example, the additional card processing can include a magnetic strip read/write system 74 that is configured to read data from and/or write data to a magnetic strip on the cards. A magnetic strip is illustrated in FIG. 5. The additional card processing may include an integrated circuit chip programming system 76 that is configured to program an integrated circuit chip on the cards. When the DOD printing mechanism 72 prints using UV curable ink, a UV cure station 78 can also be provided that contains one or more UV light emitters. Alternatively, the functions of the UV cure station 78, including the one or more UV light emitters, may be incorporated into the DOD printing mechanism 72. The construction and operation of the systems 74, 76, 78 is well known in the art. Magnetic strip read/write systems and integrated circuit chip programming systems are disclosed, for example, in U.S. Pat. No. 6,902,107 and U.S. Pat. No. 6,695,205, and can be found in the MX and MPR family of central issuance systems available from Entrust Corporation of Shakopee, Minnesota. An example of a UV radiation applicator in a card printing system is the UV curing station used in the MX™ family of card issuance systems available from Entrust Corporation of Shakopee, Minnesota.

In the system 70 illustrated in FIG. 6, one or more card inputs 80 are provided that are configured to hold a plurality of cards waiting to be processed in print jobs. Cards are fed one-by-one from the card input 80 into the rest of the system 70 where each card is individually processed. As described above, in one embodiment, the card inputs 80 can comprise one hopper that contains cards waiting to be processed and one hopper that holds one or more card shaped substrates to act as waste ink receivers.

FIG. 6 also depicts the system 70 as including a waste ink receiver bin 82 that can receive waste ink receivers when they are in the form of a card-shaped substrate like in FIGS. 4 and 5. The bin 82 is depicted as being located adjacent to the UV cure station 78 so that once the waste ink is cured, the card-shaped waste ink receiver can be transported into the bin 82 for storage and later disposal of the waste ink receiver. Alternatively, in the case of a waste ink receiver in the form of a card-shaped substrate, the waste ink receiver can be transported to a card output 84. The card output 84 may be an output slot or a bin that holds the waste ink receiver.

The card output 84 may also receive processed cards after a print job on the cards. The card output 84 may be an output slot or a bin that may be separate from the bin that holds the waste ink receiver. FIG. 3 depicts that the output 84 may be located at the same end as the input 80, the output 84 may be at an end of the system 70 opposite the input 80, or the input 80 and the output 84 can have other relative positioning to one another.

The system 70 may be configured as a desktop card personalization system. A desktop card personalization system is typically designed for relatively smaller scale, individual card personalization in relatively small volumes, for example measured in tens or low hundreds per hour, often times with a single card being processed at any one time. These card personalization machines are often termed desktop personalization machines because they have a relatively small footprint intended to permit the machine to reside on a desktop. Many examples of desktop card personalization machines are known, such as the SIGMA™ and ARTISTA™ family of desktop card printers available from Entrust Corporation of Shakopee, Minnesota. Other examples of desktop card personalization machines are disclosed in U.S. Pat. Nos. 7,434,728 and 7,398,972, each of which is incorporated herein by reference in its entirety.

Alternatively, the system 70 may be configured as a large volume batch production card personalization system (sometimes referred to as a central issuance personalization system). A large volume batch production card personalization system is configured to process multiple cards at the same time, with the cards being processed in sequence, with the cards proceeding generally along a card transport direction/transport path. A large volume batch production card personalization system typically processes cards in high volumes, for example on the order of high hundreds or thousands per hour, and employs multiple processing stations or modules to process multiple cards at the same time to reduce the overall per card processing time. Examples of such large volume card personalization machines include the MX and MPR family of central issuance personalization machines available from Entrust Corporation of Shakopee, Minnesota. Other examples of central issuance personalization machines are disclosed in U.S. Pat. Nos. 4,825,054, 5,266,781, 6,783,067, 6,902,107, and 10,049,320 all of which are incorporated herein by reference in their entirety.

Operation of the various systems 72, 74, 76, 78, 80, 82, 84 is controlled by one or more controllers 86. Alternatively, each one of the system 72, 74, 76, 78, 80, 82, 84, or select ones of the systems 72, 74, 76, 78, 80, 82, 84 can have its own dedicated controller. The sequence or arrangement of the systems 72, 74, 76, 78, 82, 84 relative to one another and relative to the card input 80 can be varied from the sequence that is illustrated in FIG. 6.

The cards can be transported through the card personalization system 70 using any suitable mechanical card transport mechanism(s) that are well known in the art. Examples of card transport mechanisms that could be used are known in the art and include, but are not limited to, transport rollers, transport belts (with tabs and/or without tabs), vacuum transport mechanisms, transport carriages, and the like and combinations thereof. Card transport mechanisms are well known in the art. A person of ordinary skill in the art would readily understand the type(s) of card transport mechanisms that could be used, as well as the construction and operation of such card transport mechanisms.

The system 70 may include additional card processing systems not illustrated in FIG. 6, which are well known in the art of card processing. For example, the system 70 may include a card embossing system that is configured to emboss characters on the cards; an indenting system that is configured to indent characters on the cards; a laminator system that is configured to apply a laminate to the cards; a laser system that uses a laser to perform laser processing such as laser marking on the cards; a topcoat station that is configured to apply a topcoat to a portion of or the entire surface of the cards; a quality control station that is configured to check the quality of personalization/processing applied to the cards; a security station that is configured to apply a security feature such as a holographic foil patch to the cards; and other card processing operations. The additional card processing systems may be located anywhere in the system 70.

In an embodiment, the cards that are printed may be plastic cards or non-plastic cards. The cards (or personalized identification cards) described herein include, but are not limited to, financial (e.g., credit, debit, or the like) cards, access cards, driver's licenses, national identification cards, and business identification cards, and other identification cards. In an embodiment, the cards may be ID-1 cards as defined by ISO/IEC 7810. However, other card formats such as ID-2 as defined by ISO/IEC 7810 are possible as well. The printing can also occur on pages, such as plastic pages, of passports as well. The passport pages can be a front cover or a rear cover of the passport, or an internal page (for example a page referred to as a data page) of the passport. In an embodiment, the passports may be in an ID-3 format as defined by ISO/IEC 7810.

The term “card” or “identification card”, unless indicated otherwise, refers to cards where the card substrate can be formed entirely of a material such as plastic, or formed of a combination of materials such as plastic and non-plastic materials. In one embodiment, the card can be sized to comply with ISO/IEC 7810 with dimensions of about 85.60 by about 53.98 millimeters (about 3 ⅜ in×about 2 ⅛ in) and rounded corners with a radius of about 2.88-3.48 mm (about ⅛ in). As would be understood by a person of ordinary skill in the art of identification cards, the cards are typically formed of multiple individual layers that form the majority of the card body or the card substrate. Similarly, the term “page” of a passport refers to passport pages where the passport can be formed entirely of a material such as plastic, or formed of a combination of materials such as plastic and non-plastic materials. An example of a passport page is the data page in a passport containing the personal data of the intended passport holder. The passport page may be a single layer or composed of multiple layers. In the case of a plastic card, examples of plastic materials that the card (or passport page), or the individual layers of the card or passport can be formed from include, but are not limited to, polycarbonate, polyvinyl chloride (PVC), polyester, acrylonitrile butadiene styrene (ABS), polyethylene terephthalate glycol (PETG), TESLIN®, combinations thereof, and other plastics.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of maintaining a drop-on-demand print head in a print mechanism of a card or passport personalization system, comprising:
within the card or passport personalization system, conducting a maintenance ejection of waste radiation curable ink from the drop-on-demand print head;
within the card or passport personalization system, applying radiation to the ejected waste radiation curable ink to cure the ejected radiation curable ink;
after the maintenance ejection, using the print mechanism to print an image on a card or a passport with radiation curable ink.

2. The method of claim 1, comprising:
in the maintenance rejection, ejecting the waste radiation curable ink from the drop-on-demand print head onto a waste ink receiver.

3. The method of claim 2, wherein the waste ink receiver comprises a card-shaped substrate.

4. The method of claim 1, after printing the image on the card or the passport and prior to printing an image on another card or another passport, conducting another maintenance ejection of additional waste radiation curable ink from the drop-on-demand print head; and
within the card or passport personalization system, applying radiation to the ejected additional waste radiation curable ink to cure the ejected additional waste radiation curable ink.

5. The method of claim 1, wherein an amount of the waste radiation curable ink ejected in the maintenance ejection is greater than an amount of the radiation curable ink used to print the image.

6. The method of claim 1, wherein applying radiation comprises applying ultraviolet radiation to the ejected waste radiation curable ink to cure the ejected waste radiation curable ink.

7. A method of maintaining a drop-on-demand print head in a print mechanism of a card or passport personalization system, comprising:
within the card or passport personalization system, conducting a maintenance ejection of waste curable ink from the drop-on-demand print head onto a waste ink receiver;
within the card or passport personalization system, curing the ejected waste curable ink;
thereafter using the print mechanism to print on a card or a passport with curable ink;
wherein an amount of the waste curable ink ejected in the maintenance ejection is greater than an amount of the curable ink used to print on the card or the passport.

8. The method of claim 7, wherein the waste ink receiver comprises a card-shaped substrate.

9. The method of claim 7, after printing on the card or the passport and prior to printing on another card or another passport, conducting another maintenance ejection of additional waste curable ink from the drop-on-demand print head; and
within the card or passport personalization system, curing the ejected additional waste curable ink.

10. The method of claim 7, wherein curing the ejected waste curable ink comprises applying ultraviolet radiation to the ejected waste curable ink to cure the ejected waste curable ink.

11. A method of maintaining a drop-on-demand print head in a print mechanism of a card or passport personalization system, comprising:
within the card or passport personalization system, conducting a maintenance ejection of waste ink from the drop-on-demand print head onto a waste ink receiver;
within the card or passport personalization system, altering the ejected waste ink;
thereafter using the print mechanism to print on a card or a passport with ink.

12. The method of claim 11, comprising:
in the maintenance rejection, ejecting the waste ink from the drop-on-demand print head onto a waste ink receiver.

13. The method of claim 12, wherein the waste ink receiver comprises a card-shaped substrate.

14. The method of claim 11, after printing on the card or the passport and prior to printing on another card or another passport, conducting another maintenance ejection of additional waste ink from the drop-on-demand print head; and
within the card or passport personalization system, altering the ejected additional waste ink.

15. The method of claim 11, wherein an amount of the waste ink ejected in the maintenance ejection is greater than an amount of the ink used to print on the card or the passport.

16. The method of claim 11, wherein altering the ejected waste ink comprises applying ultraviolet radiation to the ejected waste ink to cure the ejected waste ink.
